(19) United States
(12) Patent Application Publication
(10) Pub. No.: US 2026/0170630 A1
(43) Pub. Date: Jun. 18, 2026

(54) ANOMALY DETECTION FOR MODELS WITH LIMITED TRAINING DATA

(71) Applicant: UnitX, Inc., Santa Clara, CA (US)

(72) Inventors: Di Meng, Santa Clara, CA (US); Ruokun Ren, Redwood City, CA (US); Sota Kobayashi, San Jose, CA (US)

(21) Appl. No.: 18/984,958

(22) Filed: Dec. 17, 2024

(51) Int. Cl. G06T 7/00; G06V 10/26; G06V 10/46; G06V 10/80; G06V 10/82

(52) U.S. Cl. CPC G06T 7/0004; G06V 10/273; G06V 10/46; G06V 10/80; G06V 10/82

(57) ABSTRACT

In an example embodiment, a defect detection machine learning model is provided that is able to be trained solely using samples in which a defect is missing. These so-called “good” samples can be used so that the defect detection machine learning model learns a representation of the good samples and identifies portions of images that are outside of this representation as anomalies.

### TECHNICAL FIELD

This application relates generally to machine learning. More particularly, this application relates to anomaly detection for models with limited training data.

### BACKGROUND

Machine learning can be used in a variety of applications to perform various classification actions on digital images. One such classification is to identify “defects” in items appearing in the digital images. For example, a manufacturer may capture images of a product or part on an assembly line and use a machine learning model to identify whether the product or part has a defect that necessitates correction or destruction of the product.

### BRIEF DESCRIPTION OF DRAWINGS

FIG. 1 is a block diagram illustrating a system 100 for running a defect detection machine learning model 102, in accordance with an example embodiment.

FIG. 2 is a graph illustrating a histogram 200 of values for a particular pixel across many samples.

FIG. 3 is a flow diagram illustrating a method 300 for identifying a defect in a product depicted in an image, in accordance with an example embodiment.

FIG. 4 is a block diagram illustrating a software architecture, in accordance with an example embodiment.

FIG. 5 illustrates a diagrammatic representation of a machine in the form of a computer system within which a set of instructions may be executed for causing the machine to perform any one or more of the methodologies discussed herein.

### DETAILED DESCRIPTION

The description that follows includes illustrative systems, methods, techniques, instruction sequences, and computing machine program products that have illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

Artificial intelligence techniques for defects may involve the use of multiple different models that feed into each other. A segmentation model segments an image into smaller portions, typically grouped by common features. The portions may be called contours, as they often follow the shape of products or product portions. A classification model attempts to classify each of these contours and a defect detection model may predict whether the contours contain defects.

Training of a segmentation model involves using training data with a machine learning algorithm. The training data may be labeled (such as labeled with indications of which segments of each image in the training data are likely to have defects). The labels may be stored in the form of masks, which essentially are overlays on the image with areas of interest highlighted or marked in some way, as well as some classification (label) of the areas of interest. For example, a particular defect in a product in a sample image may be circled and classified as “defect,” while the remaining part of the image showing the product may be classified as “non-defect” and any non-product part (e.g., part of an assembly line) of the image classified as “non-product.” The machine learning algorithm then repeatedly modifies weights and other parameters in the segment model until it is “trained” to accurately predict the contours of interest in the training data. The output of each prediction made by the model is another mask, this one showing the predicted classes in the various areas. The model is essentially retrained over and over until it is reliable enough that the predicted masks match the label masks for each training image.

At that point, the segmentation model is considered trained and can be used to evaluate images that have no labels (e.g., new images taken after the segmentation model has been trained). Furthermore, some of the “training data” may be held back and not actually be used for training, but instead be used for validation, such as to validate that the segmentation model has been properly trained after training. That data, while similar or identical to training data, may be termed “validation data.”

The training of the defect detection model may follow a similar approach, with training data comprising segmented images (e.g., images with multiple identified contours from the segmentation models) and masks indicating whether the corresponding contours contain defects.

While traditional machine learning models can be easily trained using a robust combination of positive samples and negative samples as training data, this may not always be possible with product defect detection models. Defects in manufactured goods are rare. Thus, it can be difficult to obtain sample images of products with defects in them. Indeed, in some instances a defect may first appear in a product being visually inspected using a trained defect detection model, and that defect may not have been present in any training images at all or even discovered as a type of possible defect until the defect occurred. Currently, there is no mechanism to train a defect detection model in an effective manner when training images showing defects are limited or even non-existent.

In an example embodiment, a defect detection machine learning model is provided that is able to be trained solely using samples in which a defect is missing. These so-called “good” samples can be used so that the defect detection machine learning model learns a representation of the good samples and identifies portions of images that are outside of this representation as anomalies.

One concern about implementing such a defect detection machine learning model is that one would prefer to be able to provide a variable sized input and have the model have a variable receptive field. More specifically, images of products, unlike perhaps images of other items in which visual anomalies are attempted to be spotted, come in a variety of sizes. It would be beneficial to be able to feed such variable-sized images into a defect detection machine learning model without needing to scale or crop the images. Additionally, visual anomaly machine learning models typically have a fixed receptive field. This means they are only trained to look in one particular window and any defect that is present outside of this window is not able to be detected. Traditional defect detection machine learning models also can be very sensitive to irrelevant details, such as lighting, shadow, patterns in the background, etc., which can all be erroneously labeled as a defect despite not actually being a defect.

In an example embodiment, a pre-processing component is provided that acts to filter out the background of an image, thus isolating the product being examined for defects. This eliminates the possibility of the defect detection machine learning model accidentally identifying an anomaly in the background of an image.

The preprocessing image is then passed through a modified patch description network. A patch description network is a deep learning architecture used in computer vision tasks that involves matching or comparing localized regions of images, known as patches. In these tasks, an image is often divided into smaller sections, or patches, to focus on particular areas of interest. The patch description network's primary goal is to learn robust and distinctive feature representations of these patches, which can then be used for matching corresponding regions between different images or video frames.

The patch description network typically employs convolutional neural networks (CNNs) or similar deep learning architectures to process the patches and learn hierarchical feature representations. These learned features are designed to be invariant to various transformations, such as changes in scale, rotation, and lighting. This allows the network to match patches that may come from different perspectives or under varying conditions.

In practice, the network is trained to generate feature descriptions that are close for patches that correspond to the same object or scene and distant for patches that do not match. This is often done using loss functions like contrastive loss or triplet loss, which encourage the network to pull together the feature representations of matching patches while pushing apart those of non-matching patches. This process helps the model build a feature space where similar patches are close together, making it easier to match corresponding regions between images.

The patch description network might ordinarily include a small (e.g., four) number of convolutional layers with a fixed receptive field. For example, the patch description network might have a first convolutional layer with a receptive field of 33×33 pixels and thus each output feature vector describes a 33×33 patch. This patch gets eventually transformed through the convolutional layers into a 1×1×384 descriptor.

In an example embodiment, rather than a traditional patch description network, a modified patch description network is utilized. This modified patch description network may differ from a traditional patch description network in two ways. First, rather than a single chain of convolutional layers, multiple different parallel chains of convolutional layers, each having a different receptive field, are provided. The optimal ratio of combination of results from each of these chains (e.g., a weight applied to each chain's results) can be learned, or alternatively the results can simply be concatenated together and passed to a segmentation head. This allows for a variable receptive field. Second, one or more of the later convolutional layers in each chain are modified to utilize deformable convolution. This allows the detected shape to migrate through the training. Lastly, an adaptive threshold can be utilized for filtering of the result.

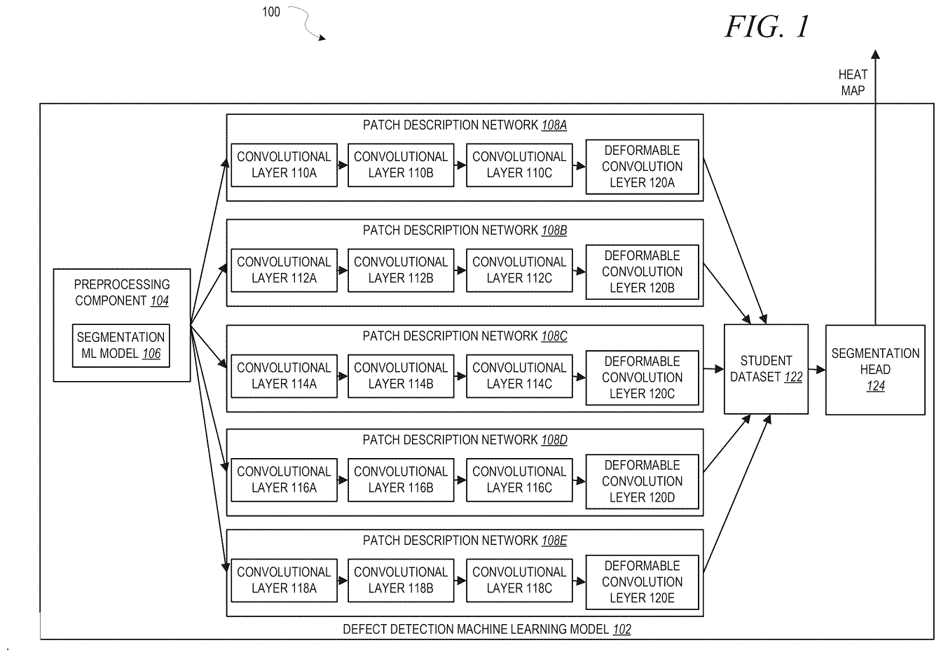

FIG. 1 is a block diagram illustrating a system 100 for running a defect detection machine learning model 102, in accordance with an example embodiment. Here, the defect detection machine learning model 102 includes a preprocessing component 104. A segmentation machine learning model 106 contained within the preprocessing component 104 is trained to identify contours within an image and isolate contours of interest from background. This may include, for example, zeroing out pixel values in the background to make those areas blank.

The preprocessed image is then passed to each of a plurality of different patch description networks 108A, 108B, 108C, 108D, 108E, each with a different receptive field size. Each patch description network 108A, 108B, 108C, 108D, 108E comprises a plurality of convolutional layers 110A, 110B, 110C, 112A, 112B, 112C, 114A, 114B, 114C, 116A, 116B, 116C, 118A, 118B, 118C. Each patch description network 108A, 108B, 108C, 108D, 108E ends with a deformable convolution layer 120A, 120B, 120C, 120D, 120E.

Unlike traditional convolution, where the convolutional filter (or kernel) moves across an image and always samples from a fixed grid of neighboring pixels, a deformable convolution allows the kernel to adapt and change its sampling locations based on the content of the image. This flexibility is achieved by introducing learned offsets that adjust the positions of the pixels being sampled, enabling the kernel to focus on more relevant or irregular areas of the image.

In a typical convolution operation, the kernel slides over the input image with a fixed stride, and at each position, it computes an output pixel by taking a weighted sum of the pixels in a pre-defined, regular grid, such as a 3×3 region. This fixed grid can be limiting, especially when dealing with objects or features that are rotated, scaled, or deformed in ways that don't align neatly with the grid. In contrast, deformable convolutions allow the positions of the pixels in the receptive field to be adjusted dynamically. This means that instead of always sampling from a fixed neighborhood, the model can learn to sample from more flexible and potentially non-adjacent locations in the image, depending on where the most important features are.

To achieve this, the network learns offsets for each pixel in the kernel's receptive field. These offsets can shift the sampling locations in any direction, allowing the convolutional filter to adapt to the structure of the object or feature being processed. Since these offsets might result in non-integer, fractional sampling locations, techniques like bilinear interpolation are often used to compute the pixel values at these new positions.

The ability to deform the receptive field gives the network greater flexibility to capture irregular patterns and objects that may not align with the regular grid of a standard convolution.

The output from each of the patch description networks 108A, 108B, 108C, 108D, 108E can then be formed into a student dataset 122.

The student-teacher approach in machine learning is a method where a smaller, more efficient model (the “student”) learns from a larger, more complex model (the “teacher”). The teacher model is typically a high-capacity neural network that has been pre-trained on a large dataset and is capable of making highly accurate predictions. The idea is that the student model, which is smaller and faster, can achieve similar performance to the teacher by learning from its outputs, rather than directly learning from the ground truth labels.

In this approach, the teacher model first undergoes training on defect detection. Once the teacher has been trained, its outputs—typically the raw logits or the probability distribution over possible classes—are used to guide the training of the student model. These outputs are referred to as “soft labels,” and they contain more nuanced information than the hard class labels typically used in training. Instead of the student model trying to match the hard labels exactly, it learns to mimic the teacher's behavior, capturing the more complex patterns that the teacher has learned from the data.

The student model (here the defect detection machine learning model 102) is trained using a combination of the teacher's soft outputs and the original ground truth labels. This process helps the student model improve its performance by learning not only to match the teacher's predictions but also to maintain accuracy with respect to the actual labels. By doing so, the student learns to generalize better and capture the essential features of the task, even though it has fewer parameters and is less computationally expensive than the teacher.

In FIG. 1 the teacher model is not pictured but generally can perform similarly to the defect detection machine learning model 102, except that it outputs soft outputs that are used to train the defect detection machine learning model 102.

A final layer, called a segmentation head 124, generates a heat map indicating on a pixel-by-pixel basis whether the corresponding pixel represents a likely defect or not. The segmentation head 124 bases this output in part on a filter threshold, which is essentially a filter that indicates whether an anomaly is considered to be a defect or not. In traditional models, this threshold is fixed. For example, the threshold may have been fixed at 99%, meaning that an anomaly would need to be different than more than 99% of samples to be considered a defect.

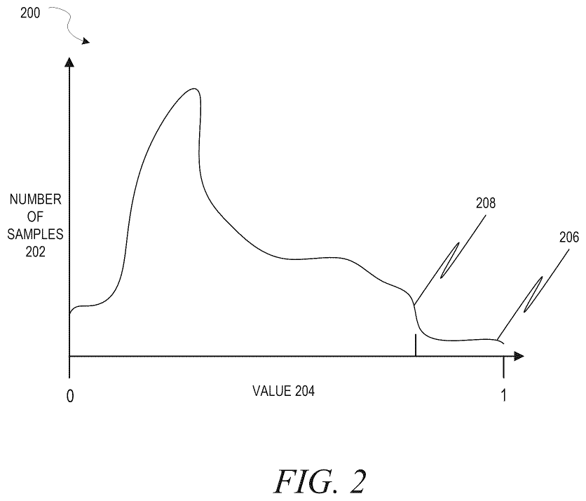

This creates a technical issue. As such, in an example embodiment, an adaptive threshold is used. FIG. 2 is a graph illustrating a histogram 200 of values for a particular pixel across many samples. On the y axis, 202 is the count of number of samples, while on the x-axis, 204 is the predicted value for the corresponding pixel from 0 (no defect detected) to 1 (defect detected). Rather than use a fixed threshold at a particular point on the graph, such as at 0.99 (here depicted at reference numeral 206), instead the graph is examined to find the steep drop off location that is closest to the right side of the graph. Essentially, the system dynamically looks for the cliff, here depicted as reference numeral 208, where the count of samples dropped sharply as it approached the “1” value. That cliff location is then selected as the threshold. This may be determined after one training has been performed.

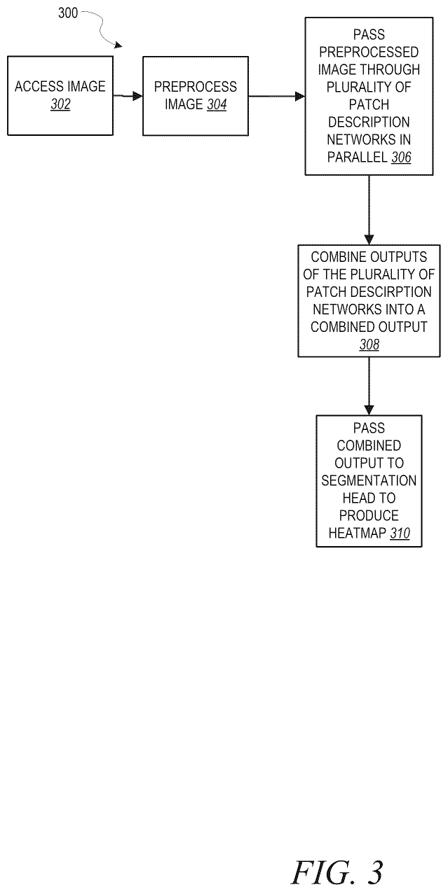

FIG. 3 is a flow diagram illustrating a method 300 for identifying a defect in a product depicted in an image, in accordance with an example embodiment. At operation 302, the image is accessed. At operation 304, the image is preprocessed by removing a background portion not containing the product. At operation 306, the preprocessed image is passed, in parallel, through a plurality of patch description networks. Each patch description network is a neural network having a different receptive field size and containing a plurality of convolutional layers, wherein a final layer in each patch description network is a deformable convolution layer.

At operation 308, outputs of the plurality of patch description networks are combined into a combined output. At operation 310, the combined output is passed to a segmentation head to produce a heatmap for the image, the heatmap identifying pixels in the image likely depicting a defect in the product.

In view of the disclosure above, various examples are set forth below. It should be noted that one or more features of an example, taken in isolation or combination, should be considered within the disclosure of this application.

Example 1 is a system comprising: a computer system comprising at least one hardware processor and a non-transitory computer-readable medium storing instructions that, when executed by the at least one hardware processor, cause the at least one hardware processor to perform operations comprising: accessing an image of a product; preprocessing the image by removing a background portion not containing the product; passing the preprocessed image, in parallel, through a plurality of patch description networks, each patch description network being a neural network having a different receptive field size and containing a plurality of convolutional layers, wherein a final layer in each patch description network is a deformable convolution layer; combining outputs of the plurality of patch description networks into a combined output; and passing the combined output to a segmentation head to produce a heatmap for the image, the heatmap identifying pixels in the image likely depicting a defect in the product.

In Example 2, the subject matter of Example 1 includes, indicating defect, the value representing a likelihood that a corresponding pixel depicts a defect in the product.

In Example 3, the subject matter of Example 2 includes, wherein the segmentation head produces the heatmap by applying a variable threshold filter, which identifies a pixel as depicting a defect in the product if the corresponding value for the pixel is greater than a variable threshold, wherein the variable threshold is determined based on an identification of a value at which a number of samples for the pixel having the value dropped significantly.

In Example 4, the subject matter of Examples 1-3 includes, wherein the combining outputs comprise concatenating the outputs.

In Example 5, the subject matter of Examples 1-4 includes, wherein the combining outputs comprise weighting each output based on a learned optimal ratio for the plurality of patch description networks.

In Example 6, the subject matter of Examples 1-5 includes, wherein the preprocessing comprises passing the image through a segmentation machine learning model.

In Example 7, the subject matter of Examples 1-6 includes, wherein the plurality of patch description networks is part of a student machine learning model trained from an output of a teacher machine learning model.

Example 8 is a method comprising: accessing an image of a product; preprocessing the image by removing a background portion not containing the product; passing the preprocessed image, in parallel, through a plurality of patch description networks, each patch description network being a neural network having a different receptive field size and containing a plurality of convolutional layers, wherein a final layer in each patch description network is a deformable convolution layer; combining outputs of the plurality of patch description networks into a combined output; and passing the combined output to a segmentation head to produce a heatmap for the image, the heatmap identifying pixels in the image likely depicting a defect in the product.

In Example 9, the subject matter of Example 8 includes, indicating defect, the value representing a likelihood that a corresponding pixel depicts a defect in the product.

In Example 10, the subject matter of Example 9 includes, wherein the segmentation head produces the heatmap by applying a variable threshold filter, which identifies a pixel as depicting a defect in the product if the corresponding value for the pixel is greater than a variable threshold, wherein the variable threshold is determined based on an identification of a value at which a number of samples for the pixel having the value dropped significantly.

In Example 11, the subject matter of Examples 8-10 includes, wherein the combining outputs comprises concatenating the outputs.

In Example 12, the subject matter of Examples 8-11 includes, wherein the combining outputs comprises weighting each output based on a learned optimal ratio for the plurality of patch description networks.

In Example 13, the subject matter of Examples 8-12 includes, wherein the preprocessing comprises passing the image through a segmentation machine learning model.

In Example 14, the subject matter of Examples 8-13 includes, wherein the plurality of patch description networks are part of a student machine learning model trained from output of a teacher machine learning model.

Example 15 is a non-transitory machine-readable storage medium having embodied thereon instructions executable by one or more machines to perform operations comprising: accessing an image of a product; preprocessing the image by removing a background portion not containing the product; passing the preprocessed image, in parallel, through a plurality of patch description networks, each patch description network being a neural network having a different receptive field size and containing a plurality of convolutional layers, wherein a final layer in each patch description network is a deformable convolution layer; combining outputs of the plurality of patch description networks into a combined output; and passing the combined output to a segmentation head to produce a heatmap for the image, the heatmap identifying pixels in the image, likely depicting a defect in the product.

In Example 16, the subject matter of Example 15 includes, indicating defect, the value representing a likelihood that a corresponding pixel depicts a defect in the product.

In Example 17, the subject matter of Example 16 includes, wherein the segmentation head produces the heatmap by applying a variable threshold filter, which identifies a pixel as depicting a defect in the product if the corresponding value for the pixel is greater than a variable threshold, wherein the variable threshold is determined based on an identification of a value at which a number of samples for the pixel having the value dropped significantly.

In Example 18, the subject matter of Examples 15-17 includes, wherein the combining outputs comprise concatenating the outputs.

In Example 19, the subject matter of Examples 15-18 includes, wherein the combining outputs comprise weighting each output based on a learned optimal ratio for the plurality of patch description networks.

In Example 20, the subject matter of Examples 15-19 includes, wherein the preprocessing comprises passing the image through a segmentation machine learning model.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

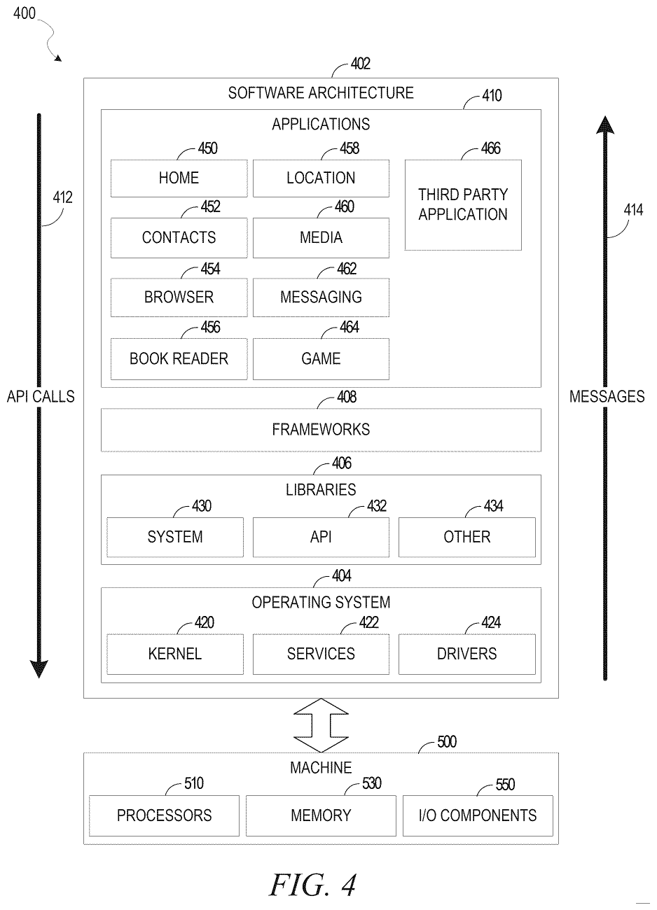

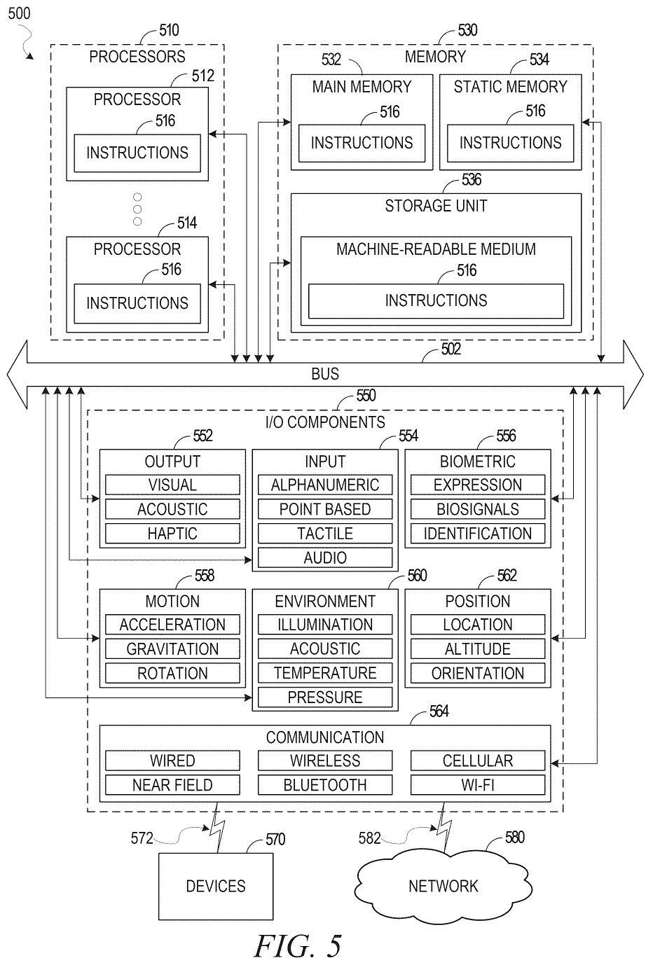

FIG. 4 is a block diagram 400 illustrating a software architecture 402, which can be installed on any one or more of the devices described above. FIG. 4 is merely a non-limiting example of a software architecture, and it will be appreciated that many other architectures can be implemented to facilitate the functionality described herein. In various embodiments, the software architecture 402 is implemented by hardware such as a machine 500 of FIG. 5 that includes processors 510, memory 530, and input/output (I/O) components 550. In this example architecture, the software architecture 402 can be conceptualized as a stack of layers where each layer may provide a particular functionality. For example, the software architecture 402 includes layers such as an operating system 404, libraries 406, frameworks 408, and applications 410. Operationally, the applications 410 invoke Application Program Interface (API) calls 412 through the software stack and receive messages 414 in response to the API calls 412, consistent with some embodiments.

In various implementations, the operating system 404 manages hardware resources and provides common services. The operating system 404 includes, for example, a kernel 420, services 422, and drivers 424. The kernel 420 acts as an abstraction layer between the hardware and the other software layers, consistent with some embodiments. For example, the kernel 420 provides memory management, processor management (e.g., scheduling), component management, networking, and security settings, among other functionalities. The services 422 can provide other common services for the other software layers. The drivers 424 are responsible for controlling or interfacing with the underlying hardware. For instance, the drivers 424 can include display drivers, camera drivers, BLUETOOTH® or BLUETOOTH® Low-Energy drivers, flash memory drivers, serial communication drivers (e.g., Universal Serial Bus (USB) drivers), Wi-Fi® drivers, audio drivers, power management drivers, and so forth.

In some embodiments, the libraries 406 provide a low-level common infrastructure utilized by the applications 410. The libraries 406 can include system libraries 430 (e.g., C standard library) that can provide functions such as memory allocation functions, string manipulation functions, mathematic functions, and the like. In addition, the libraries 406 can include API libraries 432 such as media libraries (e.g., libraries to support presentation and manipulation of various media formats such as Moving Picture Experts Group-4 [MPEG4], Advanced Video Coding [H.264 or AVC], Moving Picture Experts Group Layer-3 [MP3], Advanced Audio Coding [AAC], Adaptive Multi-Rate [AMR] audio codec, Joint Photographic Experts Group [JPEG or JPG], or Portable Network Graphics [PNG]), graphics libraries (e.g., an OpenGL framework used to render in two-dimensional [2D] and three-dimensional [3D] in a graphic context on a display), database libraries (e.g., SQLite to provide various relational database functions), web libraries (e.g., WebKit to provide web browsing functionality), and the like. The libraries 406 can also include a wide variety of other libraries 434 to provide many other APIs to the applications 410.

The frameworks 408 provide a high-level common infrastructure that can be utilized by the applications 410. For example, the frameworks 408 provide various graphical user interface functions, high-level resource management, high-level location services, and so forth. The frameworks 408 can provide a broad spectrum of other APIs that can be utilized by the applications 410, some of which may be specific to a particular operating system 404 or platform.

In an example embodiment, the applications 410 include a home application 450, a contacts application 452, a browser application 454, a book reader application 456, a location application 458, a media application 460, a messaging application 462, a game application 464, and a broad assortment of other applications, such as a third-party application 466. The applications 410 are programs that execute functions defined in the programs. Various programming languages can be employed to create one or more of the applications 410, structured in a variety of manners, such as object-oriented programming languages (e.g., Objective-C, Java, or C++) or procedural programming languages (e.g., C or assembly language). In a specific example, the third-party application 466 (e.g., an application developed using the ANDROID™ or IOS™ software development kit [SDK] by an entity other than the vendor of the particular platform) may be mobile software running on a mobile operating system such as IOS™, ANDROID™, WINDOWS® Phone, or another mobile operating system. In this example, the third-party application 466 can invoke the API calls 412 provided by the operating system 404 to facilitate functionality described herein.

FIG. 5 illustrates a diagrammatic representation of a machine 500 in the form of a computer system within which a set of instructions may be executed for causing the machine 500 to perform any one or more of the methodologies discussed herein. Specifically, FIG. 5 shows a diagrammatic representation of the machine 500 in the example form of a computer system, within which instructions 516 (e.g., software, a program, an application, an applet, an app, or other executable code) cause the machine 500 to perform any one or more of the methodologies discussed herein to be executed. For example, the instructions 516 may cause the machine 500 to execute the method 300 of FIG. 3. Additionally, or alternatively, the instructions 516 may implement FIGS. 1-3 and so forth. The instructions 516 transform the general, non-programmed machine 500 into a particular machine 500 programmed to carry out the described and illustrated functions in the manner described. In alternative embodiments, the machine 500 operates as a standalone device or may be coupled (e.g., networked) to other machines. In a networked deployment, the machine 500 may operate in the capacity of a server machine or a client machine in a server-client network environment, or as a peer machine in a peer-to-peer (or distributed) network environment. The machine 500 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 516, sequentially or otherwise, that specify actions to be taken by the machine 500. Further, while only a single machine 500 is illustrated, the term “machine” shall also be taken to include a collection of machines 500 that individually or jointly execute the instructions 516 to perform any one or more of the methodologies discussed herein.

The machine 500 may include processors 510, memory 530, and I/O components 550, which may be configured to communicate with each other such as via a bus 502. In an example embodiment, the processors 510 (e.g., a CPU, a reduced instruction set computing [RISC] processor, a complex instruction set computing [CISC] processor, a graphics processing unit [GPU], a digital signal processor [DSP], an application-specific integrated circuit [ASIC], a radio-frequency integrated circuit [RFIC], another processor, or any suitable combination thereof) may include, for example, a processor 512 and a processor 514 that may execute the instructions 516. The term “processor” is intended to include multi-core processors that may comprise two or more independent processors (sometimes referred to as “cores”) that may execute instructions 516 contemporaneously. Although FIG. 5 shows multiple processors 510, the machine 500 may include a single processor 512 with a single core, a single processor 512 with multiple cores (e.g., a multi-core processor 512), multiple processors 512, 514 with a single core, multiple processors 512, 514 with multiple cores, or any combination thereof.

The memory 530 may include a main memory 532, a static memory 534, and a storage unit 536, each accessible to the processors 510 such as via the bus 502. The main memory 532, the static memory 534, and the storage unit 536 store the instructions 516 embodying any one or more of the methodologies or functions described herein. The instructions 516 may also reside, completely or partially, within the main memory 532, within the static memory 534, within the storage unit 536, within at least one of the processors 510 (e.g., within the processor's cache memory), or any suitable combination thereof, during execution thereof by the machine 500.

The I/O components 550 may include a wide variety of components to receive input, provide output, produce output, transmit information, exchange information, capture measurements, and so on. The specific I/O components 550 that are included in a particular machine will depend on the type of machine. For example, portable machines such as mobile phones will likely include a touch input device or other such input mechanisms, while a headless server machine will likely not include such a touch input device. It will be appreciated that the I/O components 550 may include many other components that are not shown in FIG. 5. The I/O components 550 are grouped according to functionality merely for simplifying the following discussion, and the grouping is in no way limiting. In various example embodiments, the I/O components 550 may include output components 552 and input components 554. The output components 552 may include visual components (e.g., a display such as a plasma display panel [PDP], a light-emitting diode [LED] display, a liquid crystal display [LCD], a projector, or a cathode ray tube [CRT]), acoustic components (e.g., speakers), haptic components (e.g., a vibratory motor, resistance mechanisms), other signal generators, and so forth. The input components 554 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 550 may include biometric components 556, motion components 558, environmental components 560, or position components 562, among a wide array of other components. For example, the biometric components 556 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 558 may include acceleration sensor components (e.g., accelerometer), gravitation sensor components, rotation sensor components (e.g., gyroscope), and so forth. The environmental components 560 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 562 may include location sensor components (e.g., a Global Positioning System [GPS] receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 550 may include communication components 564 operable to couple the machine 500 to a network 580 or devices 570 via a coupling 582 and a coupling 572, respectively. For example, the communication components 564 may include a network interface component or another suitable device to interface with the network 580. In further examples, the communication components 564 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 570 may be another machine or any of a wide variety of peripheral devices (e.g., coupled via a USB).

Moreover, the communication components 564 may detect identifiers or include components operable to detect identifiers. For example, the communication components 564 may include radio-frequency identification (RFID) tag reader components, NFC smart tag detection components, optical reader components (e.g., an optical sensor to detect one-dimensional bar codes such as Universal Product Code [UPC] bar codes, multi-dimensional bar codes such as QR code, Aztec codes, Data Matrix, Dataglyph, Maxi Code, PDF417, Ultra Code, UCC RSS-2D bar code, and other optical codes), or acoustic detection components (e.g., microphones to identify tagged audio signals). In addition, a variety of information may be derived via the communication components 564, such as location via Internet Protocol (IP) geolocation, location via Wi-Fi® signal triangulation, location via detecting an NFC beacon signal that may indicate a particular location, and so forth.

The various memories (i.e., 530, 532, 534, and/or memory of the processor[s] 510) and/or the storage unit 536 may store one or more sets of instructions 516 and data structures (e.g., software) embodying or utilized by any one or more of the methodologies or functions described herein. These instructions (e.g., the instructions 516), when executed by the processor(s) 510, cause various operations to implement the disclosed embodiments.

As used herein, the terms “machine-storage medium,” “device-storage medium,” and “computer-storage medium” mean the same thing and may be used interchangeably. The terms refer to single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 580 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 580 or a portion of the network 580 may include a wireless or cellular network, and the coupling 582 may be a Code Division Multiple Access (CDMA) connection, a Global System for Mobile communications (GSM) connection, or another type of cellular or wireless coupling. In this example, the coupling 582 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 5G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 516 may be transmitted or received over the network 580 using a transmission medium via a network interface device (e.g., a network interface component included in the communication components 564) and utilizing any one of a number of well-known transfer protocols (e.g., Hypertext Transfer Protocol [HTTP]). Similarly, the instructions 516 may be transmitted or received using a transmission medium via the coupling 572 (e.g., a peer-to-peer coupling) to the devices 570. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 516 for execution by the machine 500, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A system comprising:
a computer system comprising at least one hardware processor and a non-transitory computer-readable medium storing instructions that, when executed by the at least one hardware processor, cause the at least one hardware processor to perform operations comprising:
accessing an image of a product;
preprocessing the image by removing a background portion not containing the product;
passing the preprocessed image, in parallel, through a plurality of patch description networks, each patch description network being a neural network having a different receptive field size and containing a plurality of convolutional layers, wherein a final layer in each patch description network is a deformable convolution layer;
combining outputs of the plurality of patch description networks into a combined output; and
passing the combined output to a segmentation head to produce a heatmap for the image, the heatmap identifying pixels in the image likely depicting a defect in the product.

2. The system of claim 1, wherein the segmentation head produces, for each pixel, a value between 0 and 1, with 0 indicating no defect and 1 indicating defect, the value representing a likelihood that a corresponding pixel depicts a defect in the product.

3. The system of claim 2, wherein the segmentation head produces the heatmap by applying a variable threshold filter, which identifies a pixel as depicting a defect in the product if the corresponding value for the pixel is greater than a variable threshold, wherein the variable threshold is determined based on an identification of a value at which a number of samples for the pixel having the value dropped significantly.

4. The system of claim 1, wherein the combining outputs comprises concatenating the outputs.

5. The system of claim 1, wherein the combining outputs comprises weighting each output based on a learned optimal ratio for the plurality of patch description networks.

6. The system of claim 1, wherein the preprocessing comprises passing the image through a segmentation machine learning model.

7. The system of claim 1, wherein the plurality of patch description networks is part of a student machine learning model trained from an output of a teacher machine learning model.

8. A method comprising:
accessing an image of a product;
preprocessing the image by removing a background portion not containing the product;
passing the preprocessed image, in parallel, through a plurality of patch description networks, each patch description network being a neural network having a different receptive field size and containing a plurality of convolutional layers, wherein a final layer in each patch description network is a deformable convolution layer;
combining outputs of the plurality of patch description networks into a combined output; and
passing the combined output to a segmentation head to produce a heatmap for the image, the heatmap identifying pixels in the image likely depicting a defect in the product.

9. The method of claim 8, wherein the segmentation head produces, for each pixel, a value between 0 and 1, with 0 indicating no defect and 1 indicating defect, the value representing a likelihood that a corresponding pixel depicts a defect in the product.

10. The method of claim 9, wherein the segmentation head produces the heatmap by applying a variable threshold filter, which identifies a pixel as depicting a defect in the product if the corresponding value for the pixel is greater than a variable threshold, wherein the variable threshold is determined based on an identification of a value at which a number of samples for the pixel having the value dropped significantly.

11. The method of claim 8, wherein the combining outputs comprises concatenating the outputs.

12. The method of claim 8, wherein the combining outputs comprises weighting each output based on a learned optimal ratio for the plurality of patch description networks.

13. The method of claim 8, wherein the preprocessing comprises passing the image through a segmentation machine learning model.

14. The method of claim 8, wherein the plurality of patch description networks are part of a student machine learning model trained from output of a teacher machine learning model.

15. A non-transitory machine-readable storage medium having embodied thereon instructions executable by one or more machines to perform operations comprising:
accessing an image of a product;
preprocessing the image by removing a background portion not containing the product;
passing the preprocessed image, in parallel, through a plurality of patch description networks, each patch description network being a neural network having a different receptive field size and containing a plurality of convolutional layers, wherein a final layer in each patch description network being a deformable convolution layer;
combining outputs of the plurality of patch description networks into a combined output; and
passing the combined output to a segmentation head to produce a heatmap for the image, the heatmap identifying pixels in the image likely depicting a defect in the product.

16. The non-transitory machine-readable storage medium of claim 15, wherein the segmentation head produces, for each pixel, a value between 0 and 1, with 0 indicating no defect and 1 indicating defect, the value representing a likelihood that a corresponding pixel depicts a defect in the product.

17. The non-transitory machine-readable storage medium of claim 16, wherein the segmentation head produces the heatmap by applying a variable threshold filter, which identifies a pixel as depicting a defect in the product if the corresponding value for the pixel is greater than a variable threshold, wherein the variable threshold is determined based on an identification of a value at which a number of samples for the pixel having the value dropped significantly.

18. The non-transitory machine-readable storage medium of claim 15, wherein the combining outputs comprises concatenating the outputs.

19. The non-transitory machine-readable storage medium of claim 15, wherein the combining outputs comprises weighting each output based on a learned optimal ratio for the plurality of patch description networks.

20. The non-transitory machine-readable storage medium of claim 15, wherein the preprocessing comprises passing the image through a segmentation machine learning model.
